(19) United States
(12) Patent Application Publication
(10) Pub. No.: US 2026/0198750 A1
(43) Pub. Date: Jul. 16, 2026

(54) SYSTEM AND METHOD TO MONITOR A WAREWASHER AND THE LIKE

(71) Applicant: BWL GLOBAL S.À R.L., Luxembourg (LU)

(72) Inventor: Robert Scott Brooks, Scottsdale, AZ (US)

(21) Appl. No.: 18/923,575

(22) PCT Filed: Apr. 29, 2022
(86) PCT No.: PCT/US2022/026986

§ 371 Date: Oct. 22, 2024

(51) Int. Cl. A47L 15/00; A47L 15/44; G06Q 10/20

(52) U.S. Cl. CPC A47L 15/0063; A47L 15/0049; A47L 15/4472; G06Q 10/20; A47L 2401/023; A47L 2401/12; A47L 2501/36

(57) ABSTRACT

An improved system and method of monitoring warewashers is provided. The system includes a warewasher and chemical dispenser in communication with a computer system and a plurality of sensors configured to collect data regarding the warewasher component parts and chemical dispenser functionality. The computer system sends messages to a central server for the purpose of monitoring and maintenance. The central server compiles information, calculates and predicts failure. Then the central server sends a signal back to the warewasher and to a technician, such that the technician can be dispatched to address issues regarding the warewasher and the chemical dispenser.

### CROSS-REFERENCE TO RELATED APPLICATIONS

N/A

### BACKGROUND OF THE INVENTION

### 1. Field of the Invention

The present invention generally relates to commercial warewashers, but more particularly to an improved system and method to monitor a warewasher and the like.

### 2. Description of Related Art

Since the 1950s, the warewashing industry has been a primitively mechanical one. Typical warewashing machines are run by a mechanical timer, thus proving to be highly durable, yet inflexible and unintelligent. To manage these machines and their fairly regular need for maintenance, chemical and equipment supply companies visit the food service facility and inspect the equipment, almost always adjust and tune the various components and when necessary repairing anything broken, or replacing worn out parts/assemblies. Since the revenue is fixed and technician time is expensive, machine is running properly more often than not, the chemical supply company's incentive is to increase time between visits and delay maintenance schedules to maximize profits. This results in episodes during the year when the machine is not operating properly, is out of regulatory compliance and very often unsanitary, and putting unknowing patrons at a health risk.

The food service facility almost always takes on the responsibility of monitoring chemical levels. This most often means the lowest skilled person(s) inside the kitchen operation, the warewasher or other unskilled labor are charged with being sure all chemicals have not run “dry” and that they are dispensing properly (no vacuum breaks or loss of prime for example). Some chemicals are especially difficult to monitor because they are blended with substantial amounts of water on their way to their cleaning process, therefore volume or flow problems are difficult to discern.

Finally, all of this monitoring often requires up to 30 days given the typical offering of “free monthly service” for the human-intervention of a qualified chemical supply company employee to notice a state change in chemical or machine, diagnose the change, and then report that issue properly to the decision maker and take action. In turn, chemical supply companies must properly “triage” the issue based on often poor technical communication from the field and respond in a timely and profit-protecting manner (given that revenues are most often a fixed monthly amount).

Thus, there is a quality of service and safety need for an equipment use (food service facility, etc) to bypass the convoluted chain from the current manual, local, and clumsy machine monitoring as well as supply company communication quality and repairmen dispatch biases to a crisp, confirmable, and monitorable computer network communication system.

### BRIEF SUMMARY OF THE INVENTION

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a network communication system according to an embodiment of the present invention;

FIG. 2 is a flow diagram illustrating a method to monitor chemical levels in a warewasher according to an embodiment of the present invention;

FIG. 3 is a flow diagram illustrating a method to monitor warewasher components performance functions according to an embodiment of the present invention; and,

FIG. 4 illustrates a system and method to monitor a warewasher according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide an improved system and method to monitor a warewasher and the like.

The word “a” is defined to mean “at least one.” The word “warewasher” is generally defined as a commercial dishwasher configured to wash food service industry kitchenware. The word “kitchenware” is generally defined as any food service industry item that may be cleaned in the warewasher such as dinnerware, flatware, glassware, etc. The word “customer site” is defined as “any location where a warewasher is installed.” The terminology includes the words above specifically mentioned, derivatives thereof, and words of similar import.

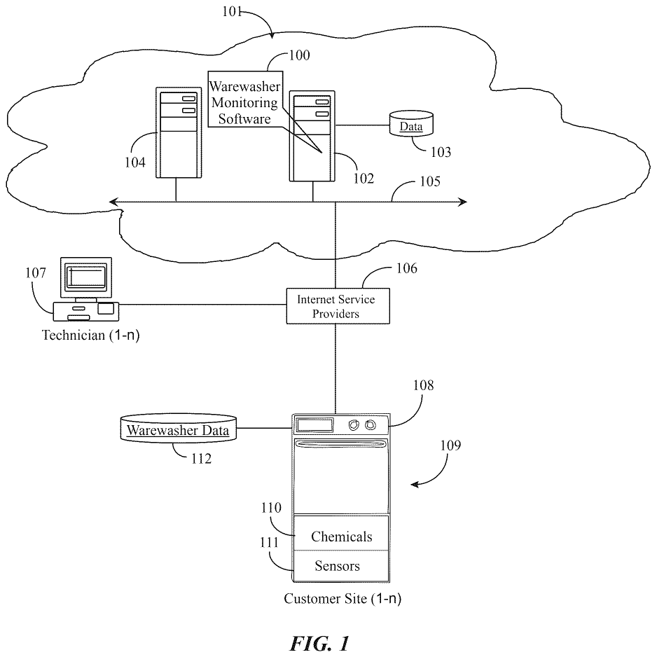

FIG. 1 is a network communication system 101 according to an embodiment of the present invention. Referring to FIG. 1, the network communication system comprises one or more Internet-connected central servers 102 executing warewasher monitoring software 100 from non-transitory media. Central server 102 is connected to a data repository 103, which may be any sort of data storage known in the art. The system further comprises a third party Internet-connected server 104 connected to Internet backbone 105. Although one third party Internet-connected server 104 is shown, it is understood that potentially millions of other similar servers are connected to the Internet via Internet backbone 105. A number of technicians (1-n) 107 are connected to the Internet-connected central server via an Internet service provider (ISP) 106, allowing communication between the central server and the technicians. In alternative embodiments, the number of technicians may not have direct communication with the central server. For instance, a one-way connection may be provided, wherein the central server may communicate with the number of technicians by a variety of methods. This will be discussed in greater detail below. In yet another embodiment, a managing user may be in communication with the central server, wherein the managing user may communicate with the number of technicians outside of the described network. Also connected to the network communication system is at least one warewasher computer system 108 connected to at least one warewasher 109 situated at a number of customer sites (1-n). In addition to the warewasher computer system, each warewasher includes a number of chemical vessels and dispensers 110 configured to release chemicals during warewashing cycles (rinse and wash), and a number of sensors 111 configured to monitor a number of functions, including but not limited to warewashing components, wash and rise temperatures, and chemical levels both in the vessels and dispensed via the dispensers. In one embodiment, each warewasher computer system is connected to a warewasher data repository 112. Although a warewasher is described, it should be understood that any food service facility equipment machine, chemical vessel, supply unit, cleaning equipment, sanitation equipment, etc. may also be connected to the communication system.

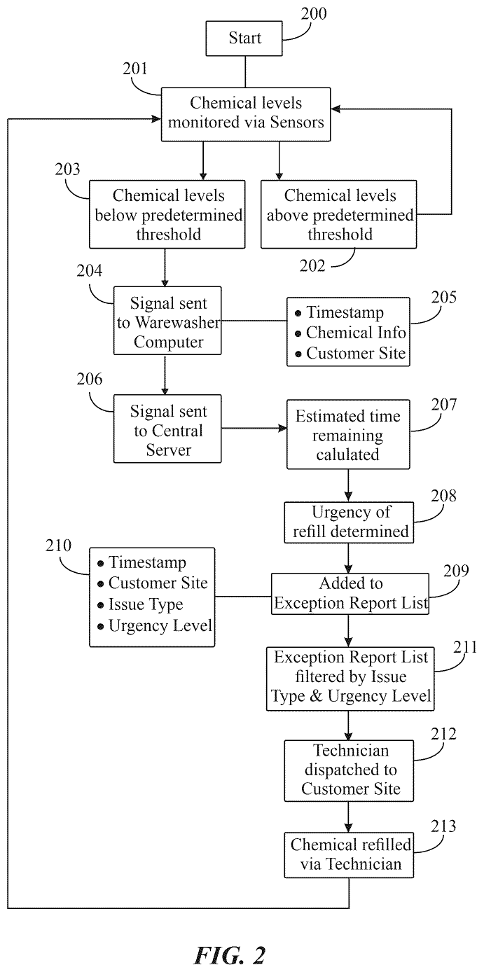

FIG. 2 is a flow diagram illustrating a method 200 to monitor chemical levels in a warewasher according to an embodiment of the present invention. Referring now to FIG. 2, in step 201, chemical levels are monitored via sensors. In one embodiment, sensors are positioned on each chemical storage vessel, wherein in each sensor is configured to monitor the chemical level or volume in a specific chemical storage vessel. In one embodiment, a predetermined threshold level (volume level) is programmed via the warewasher computer system and sensors, wherein the predetermined threshold is a volume of chemical remaining where a refill is required. In one embodiment, the predetermined threshold is a level when the volume equals a proper and safe refill level allowing for safety tolerances ensuring refill prior to the volume depleting. Thus, if the chemical levels are above the predetermined threshold level 202, the system continues to monitor the chemical levels. However, if any chemical levels are below the predetermined threshold 203, the sensor sends a signal to the warewasher computer 204. The data sent 205 includes the chemical information and the timestamp in which the threshold was breached, as well as the location of the warewasher (customer site). It should be appreciated, that the predetermined threshold is set based on a variety of factors, including but not limited to chemical type and rate or volume dispensed of the chemical during wash and rinse cycles.

Next, in step 206, the signal is sent from the warewasher computer to the central server with the associated data as previously mentioned, including but not limited to a timestamp, chemical info, and also the customer site, i.e. the location of the warewasher. In one embodiment, the chemical info includes the specific chemical that breached the predetermined threshold and the volume of the specific chemical. Next, in step 207, the warewasher monitoring software on the central server calculates the estimated length of time remaining before the volume of the chemical depletes to zero. Based on the estimated time remaining of step 207, an urgency of refill is determined 208. In one embodiment, the urgency is a numerical value. In alternative embodiments, the urgency is a predetermined indicator of varying priority levels, “high”, “low”, etc. based on the estimated time remaining. In some embodiments, the urgency is ranked in relation to other customer sites on a report list, which will be discussed in greater detail below.

In one embodiment, the urgency of step 208 is added to a report list in step 209. The other data obtained is also added to the report list, including the timestamp, customer site (warewasher location), issue type (low volume of a specific chemical), and urgency level. Next, in step 211, the report list is filtered by issue type and urgency level, such that the issues are ranked in order of urgency for the various customer sites. In step 212, a technician is dispatched to the customer site. Finally, in step 213, the technician fixes the issue, e.g. refilling a chemical, in which case the system continues to monitor the chemical levels.

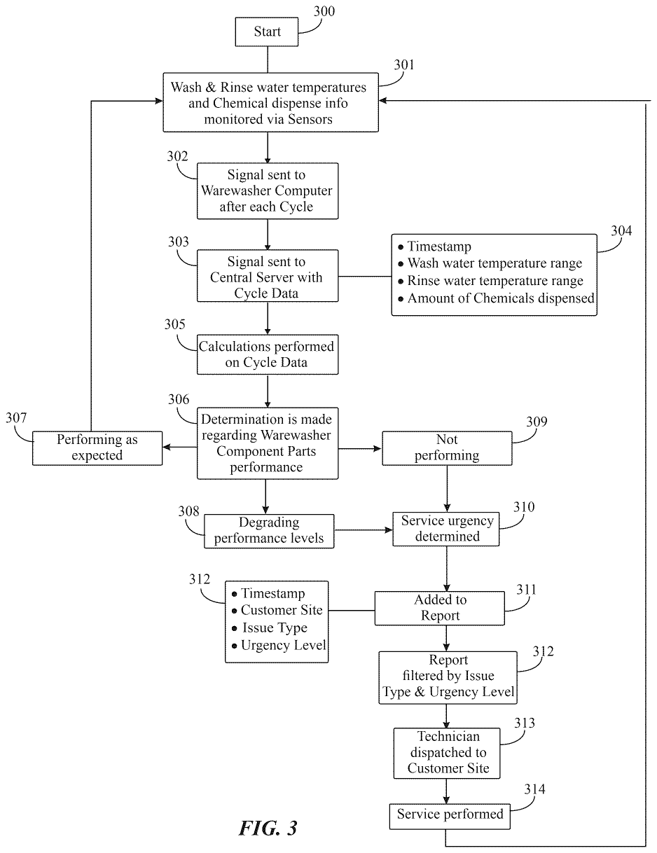

FIG. 3 is a flow diagram illustrating a method 300 to monitor warewasher components performance functions according to an embodiment of the present invention. Referring now to FIG. 3, in step 301, wash and rinse temperatures and chemical dispense volume amounts per cycle are monitored via sensors. In step 302, a signal is sent to the warewasher computer after each wash and rinse cycle. Next, in step 303, the warewasher computer sends a signal to the central server, wherein the signal includes warewasher cycle data 304. In one embodiment, the cycle data includes a timestamp of the cycle, the wash water temperature range, the rinse water temperature range, and the amount of chemicals dispensed in the cycle. In one embodiment, the signal sent to the central server is after each cycle as previously described. In alternative embodiments, the signal may be sent in predetermined increments based on time, e.g. once a day, or after a predetermined amount of cycles. The frequency may be determined by the specific customer site and the needs of that specific customer site. Next, in step 305, the warewasher monitoring software on the central server performs calculations on the warewasher cycle data to determine if the warewasher components are functioning properly 306. For instance, if the wash and rinse temperatures ranges are different than expected, a component is either not functioning properly or possibly it may be a problem with the water supply from the food service facility. In another exemplary instance, if the chemical dispense volume amount is lower than expected the chemical dispenser is likely not functioning properly. These are just two instances, but it should be understood that a number of scenarios are possible. It should be understood, that the warewasher water temperature ranges may vary depending on the type of warewasher used, i.e. high, mid, or low temperature warewasher. Thus, expected performance is based on the range of temperatures for either the wash and/or rinse cycle, not how high or low the temperature is recorded. Further, in some instances, the warewasher may be waterless. The central server has the advantage of data from a number of warewashers experiencing many cycles, as well as component degradation from historical data and comparisons, aiding in the calculations to determine if warewasher components are functioning properly. In one embodiment, the warewasher computer performs the above performance calculations. In alternative embodiments, the calculations are performed via automated or other means well known in the art.

Still referring to FIG. 3, if the warewasher components are performing as expected 307, the system continues to monitor the warewashing features and components as normal. If a determination is made that the warewasher component parts are showing degrading performance levels 308 or are not performing 309, a service urgency is determined in step 310. In one embodiment, the service urgency is determined based on how the component parts are performing in relation to their expected performance. Thus, one of skill of the art may appreciate that as the gap between expected performance and actual performance increases, the urgency increases. Next, the urgency of step 310 is added to a report list in step 311. The other data obtained is also added to the report list, including the timestamp, customer site (warewasher location), issue type, and urgency level. The issue type is the problem for the specific warewasher, e.g. component with degrading performance levels. Next, in step 312, the report list is filtered by issue type and urgency level, such that the issues are ranked in order of urgency for the various customer sites, as well as grouped efficiently based on location. In step 313, a technician is dispatched to the customer site, and finally in step 314, the service is performed and technician fixes the issue, in which case the system continues to monitor the warewashing features and components as normal.

In one embodiment, the central server and monitoring software notifies the technician of an urgency (either refill or service) via email, automated phone message, text message, print out, or combination thereof. Likewise, the urgency is added to the report list which the technician has access to via his computer system via the Internet network communication system. The computer system may be a desktop computer, laptop computer, tablet, and mobile phone as well known in the art. In one embodiment, the order to dispatch the technician is automated via the central server. In alternative embodiments, a managing user or an employee tasked with monitoring the central server and the warewasher monitoring software orders or managing the dispatching of technicians. In one embodiment, a mapping service provides a route plan for the technician based on the urgency level and grouping of the required service locations. It is a particular object of the present invention, to provide an efficient means to service a number of customer sites based on urgency and location of the sites.

The methods described above provides an improvement to the use of warewashers and the like, increases patron safety by limiting unsanitary conditions in the food service facility, improving kitchenware cleanliness, and reduces human monitoring inefficiencies. Since, the central server gathers warewashing data from each warewashing machine at each customer site, the warewashing monitoring software can run component part checks and mean-time-to-failure calculations across all warewashing machines to better predict failure and to treat some flagged issues with greater urgency. The system can also run full historical performance data to better predict future chemical use and performance of warewashers and chemical dispensers.

Additionally, the methods described above provide a system in which a technician may be dispatched to provide repairs or service to a warewashing machine prior to the customer site being aware that there was problem. This significantly reduces the burden of the customer site to monitor the warewashing machine, and chemical dispensers for performance issues that may lead to unsanitary conditions for their patrons.

Further, the system and methods described solves a number of technical problems. Traditionally, a food service facility operator has to train personnel to monitor chemicals and mechanical aspects of the warewashing equipment and chemical dispensers. In some instances, the operator has to train personnel how to respond to technical issues flagged by the warewashing system, effectively training a low level employee to be a warewasher technician. In the aforementioned system and method, the central servicer receives messages regarding total performance hundreds of times per day, which isn't practical for human monitoring. Human monitoring is infrequent, inconsistent, often ignored, and error prone. Likewise, scheduled monitoring and maintenance is too infrequent, error prone, and subject to abuse and therefore risks patron safety. The method and system described is consistent, frequent, and focuses human attention on performance exceptions. Traditionally, a technician is often only aware of the problem and able to fix the problem long after it was first noticed. In contrast, using the present invention, the technician is often aware and on the job before the warewashing site is even aware of it.

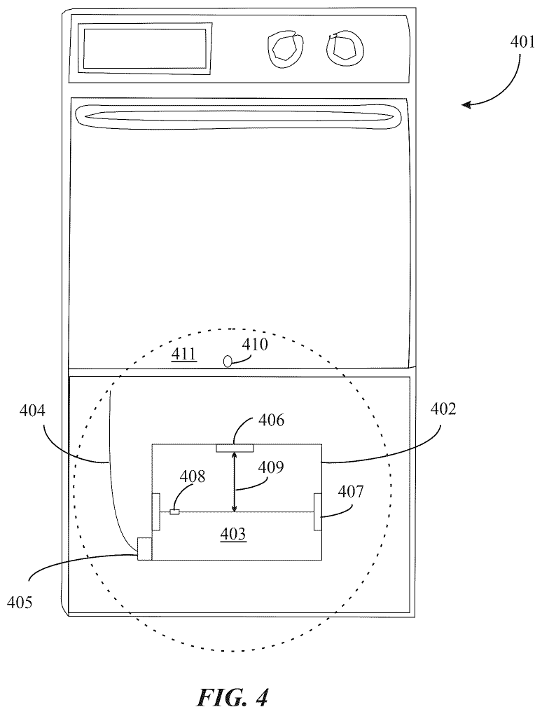

FIG. 4 illustrates a system and method to monitor a warewasher according to an embodiment of the present invention. Referring now to FIG. 4, an exemplary arrangement of system components are illustrated in a warewasher 401. The warewasher may be any warewasher known in the art, including but not limited to an upright warewasher, conveyer warewasher, waterless warewasher, dishwasher, or any warewasher configured to wash wares as well known in the art. In one embodiment, a chemical vessel 402 having a chemical volume 403 is positioned in a storage area of the warewasher. In alternative embodiments, the chemical vessel may be positioned adjacent to the warewasher. A fluid conduit 404 is in fluid communication with the warewasher and chemical vessel. As previously mentioned, a chemical dispenser 405 is configured to deliver a predetermined volume of chemical during a warewasher cycle. In one embodiment, the chemical dispenser operates via a pump or other methods known in the art. As previously mentioned, a plurality of sensors may be utilized to determine the volume of chemical remaining in the vessel. In one exemplary instance, a ultrasonic sensor 406 configured to detect a distance 409 may be positioned on a top portion of the chemical vessel, a capacitive sensor 407 may be positioned in a side portion of the chemical vessel configured to detect when the volume of chemical is no longer present on one or more sides of the vessel, and a float sensor 408 configured to detect the level of volume within the vessel. In one embodiment, at least one thermistor sensor 410 is positioned in a wash and/or rinse basin 441, wherein the at least one thermistor sensor is configured to monitor the aforementioned temperature ranges. It should be understood that other arrangement may be utilized, without departing from the scope of the invention.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, in one embodiment, the central server is configured to send a data signal back to the warewasher computer after the central server and monitoring software performs the step of making a determination regarding warewasher component parts performance as well as the calculation of estimated time remaining before a specific chemical runs out. This way, if desired, a customer site employee may fix the issue prior to the dispatching of the technician, as some of the issues might not be apparent until the central server and monitoring software performs the calculations and determinations. Further, the technician on site may verify the issue via the warewasher computer when arriving on location.

In addition, reference to “first,” “second,” “third,” and etc. members throughout the disclosure (and in particular, claims) are not used to show a serial or numerical limitation but instead are used to distinguish or identify the various members of the group.

What is claimed is:

1. An improved method to monitor a number of warewashers at a number of customer sites, comprising steps:
(a) providing a plurality of sensors on each warewasher of the number of warewashers, wherein each warewasher includes a warewasher computer and is configured to operate a wash cycle at a first temperature and a rinse cycle at a second temperature for washing and rinsing kitchenware respectively, wherein each warewasher is coupled to at least one chemical vessel and at least one corresponding chemical dispenser, wherein the at least one chemical vessel has a first volume of a chemical, and the at least one chemical dispenser is configured to dispense a second volume of the chemical during the wash cycle and/or the rinse cycle, wherein the plurality of sensors include an ultrasonic sensor positioned on a top portion of the at least one chemical vessel, wherein the ultrasonic sensor is configured to detect a distance between the top portion of the at least one chemical vessel and liquid level line of the first volume of the chemical within the at least one chemical vessel, a float sensor within the at least one chemical vessel, wherein the float sensor is configured to detect the first volume of the chemical within the at least one chemical vessel; a capacitive sensor positioned on an inner side wall portion of the at least one chemical vessel, wherein the capacitive sensor is configured to detect with the first volume of the chemical is no longer present on the inner side wall portion of the at least one chemical vessel; at least one thermistor sensor positioned in a wash and/or rinse basin of the at least one warewasher, wherein the at least one thermistor sensor is configured to monitor the first temperature and the second temperature; the at least one chemical dispenser having a dispensing sensor configured to monitor the second volume dispensed;
(b) monitoring, via the plurality of sensors, the first volume via the ultrasonic sensor, the float sensor, and the capacitive sensor, the second volume via the dispensing sensor, the first temperature and the second temperature via the at least one thermistor sensor;
(c) sending a first signal, via the plurality of sensors, to the warewasher computer, the first signal having a warewasher dataset including a timestamp, a customer site location of the number of customer sites, the first volume, the second volume, the first temperature, and the second temperature;
(c) sending a second signal at a predetermined frequency, via the warewasher computer, to a central server, the second signal having the warewasher dataset;
(d) calculating, via the central server, warewasher and chemical dispenser performance based on the warewasher dataset;
(e) determining, via the calculations, if the warewasher and the at least one chemical dispenser are performing as expected, not performing, or having degrading performance;
(f) determining a service urgency level if the warewasher and/or the at least one chemical dispenser are not performing or having degrading performance;
(g) adding the service urgency level to an exception report list;
(h) dispatching a service technician to the customer site location;
(i) performing service, via the service technician, on the warewasher and/or the at least one chemical dispenser; and,
(j) creating a predetermined threshold in relation to the first volume, wherein if the first volume falls below the predetermined threshold a third signal is sent to the central server via the warewasher computer, wherein the third signal includes a second warewasher dataset comprising a second timestamp, the chemical, the first volume, and the customer site location.

2. The improved method of claim 1, wherein in step (e), the determination for the degrading performance levels is based on historical comparisons.

3. The improved method of claim 1, wherein the central server calculates an estimated time remaining corresponding to when the first volume equals zero.

4. The improved method of claim 1, further comprising a step of filtering the exception list by service urgency level for the number of customer sites such that a service urgency level ranking is established.

5. The improved method of claim 4, wherein the ranking comprises a rank of service urgency levels for each customer site location of the number of customer sites such that a priority and response for the dispatching of the service technician is based on the service urgency level ranking and locations of the number of the customer sites such that a grouping is provided corresponding to an efficient route plan for the dispatched service technician.

6. The improved method of claim 5, wherein the efficient route plan is provided by a mapping service.

7. The improved method of claim 1, wherein each warewasher includes a warewasher computer.

8. The improved method of claim 7, further comprising steps:
sending a first signal, via the plurality of sensors, to the warewasher computer, wherein the first signal includes the warewasher dataset; and,
sending a second signal at a predetermined frequency, via the warewasher computer, to the central server, wherein the second signal includes the warewasher dataset.

9. An improved system to monitor a number of warewashers at a number of customer sites comprising:
a central server connected to an Internet computer network;
at least one warewasher at a customer site having a warewasher computer connected to the Internet computer network in communication with the central server, the at least one warewasher configured to operate a wash cycle at a first temperature and a rinse cycle at a second temperature for washing and rinsing kitchenware respectively, wherein the at least one warewasher is coupled to at least one chemical vessel and at least one chemical dispenser, wherein the at least one chemical vessel has a first volume of a chemical, and the at least one chemical dispenser is configured to dispense a second volume of the chemical during the wash cycle and/or the rinse cycle;
an ultrasonic sensor positioned on a top portion of the at least one chemical vessel, wherein the ultrasonic sensor is configured to detect a distance between the top portion of the at least one chemical vessel and liquid level line of the first volume of the chemical within the at least one chemical vessel;
a float sensor within the at least one chemical vessel, wherein the float sensor is configured to detect the first volume of the chemical within the at least one chemical vessel;
a capacitive sensor positioned on an inner side wall portion of the at least one chemical vessel, wherein the capacitive sensor is configured to detect with the first volume of the chemical is no longer present on the inner side wall portion of the at least one chemical vessel;
at least one thermistor sensor positioned in a wash and/or rinse basin of the at least one warewasher, wherein the at least one thermistor sensor is configured to monitor the first temperature and the second temperature;
wherein the at least one chemical vessel and at least one chemical dispenser is positioned within the at least one warewasher, the at least one chemical dispenser having a dispensing sensor configured to monitor the second volume dispensed, wherein the ultrasonic sensor, the float sensor, the capacitive sensor, the at least one thermistor sensor, and the dispensing sensor are in communication with the warewasher computer;
at least one technician having a computer connected to the Internet computer network, wherein the computer is in communication with the central server;
the warewasher computer configured to send a data signal to the central server, wherein the data signal includes a timestamp, the customer site, the first volume, the second volume, the first temperature, and the second temperature; and,
the central server configured to execute a warewasher monitoring software from non-transitional media connected to a data repository, the warewasher monitoring software configured to monitor the data signal for issues related to the at least one warewasher, the at least one chemical vessel, and the at least one corresponding chemical dispenser, wherein the warewasher monitoring software is configured to add the issues to an exception report accessible to the at least one technician via the computer such that the at least one technician can perform service and fix issues at the customer site.

11. The improved system of claim 10, wherein the central server notifies the at least one technician of the issues via email, automated phone message, text message, or combination thereof.

12. The improved system of claim 10, wherein the computer is selected from the group consisting of: a desktop computer, a laptop computer, a tablet, and a mobile phone.
